(19) United States
(12) Patent Application Publication
(10) Pub. No.: US 2018/0222784 A1
(43) Pub. Date: Aug. 9, 2018

(54) METHOD OF CONTROLLING OPTICAL ELEMENT MANUFACTURING APPARATUS, MEHTOD OF MANUFACTURING OPTICAL ELEMENT, AND OPTICAL ELEMENT MANUFACTURING APPARATUS

(71) Applicant: OLYMPUS CORPORATION, Tokyo (JP)

(72) Inventor: Ikunori HIROSE, Tokyo (JP)

(73) Assignee: OLYMPUS CORPORATION, Tokyo (JP)

(21) Appl. No.: 15/946,222

(22) Filed: Apr. 5, 2018

Related U.S. Application Data
(63) Continuation of application No. PCT/JP2016/077515, filed on Sep. 16, 2016.

(30) Foreign Application Priority Data
Oct. 13, 2015 (JP) 2015-201911

(51) Int. Cl. C03B 11/12

(52) U.S. Cl. CPC C03B 11/122; C03B 2215/46; C03B 11/125

(57) ABSTRACT

A method of controlling an optical element manufacturing apparatus includes: heating a cavity formed of a pair of upper and lower dies to a first temperature where an optical element material softens and becomes formable by the pair of dies; heating the cavity to a second temperature where the optical element material is deformed due to a weight of the optical element material in a state of not being in contact with the upper die, the second temperature being higher than the first temperature; and pressing the pair of dies for transfer of forming surfaces of the pair of dies onto the optical element material, the forming surfaces being outside a range where a forming surface of a die has been transferred by the deformation due to the weight in the state where the optical element material is not in contact with the upper die at the second temperature.

### CROSS-REFERENCE TO RELATED APPLICATION

This application is a continuation of PCT International Application No. PCT/JP2016/077515 filed on Sep. 16, 2016 which claims the benefit of priority from Japanese Patent Application No. 2015-201911, filed on Oct. 13, 2015, the entire contents of which are incorporated herein by reference.

### BACKGROUND

The present disclosure relates to a method of controlling an optical element manufacturing apparatus, a method of manufacturing an optical element, and an optical element manufacturing apparatus.

In recent years, a method of manufacturing an optical element by so-called press forming has been known, in which a thermoplastic optical element material, such as glass, is heated and pressed by a forming die and a forming surface of the forming die is transferred onto an optical functional surface of the optical element material. In this method of manufacturing an optical element by press forming, the transfer may not progress symmetrically about the central axis, because of: positional displacement or slanting of the optical element material occurring when press forming of the optical element material via upper and lower dies is started; or transfer being started from a position displaced from the center of forming surfaces of the dies due to a slant between the upper and lower dies. In such a case, particularly for a combination of an aspherically shaped forming surface of a die and a spherically shaped optical element material, or a combination of a forming surface of a die and an optical element material that have similar curvatures; there has been a problem that a portion, in which gas is trapped between the optical element material and the forming surface of the die, is generated around a top portion of the forming surface, and collection of air is caused on the optical element surface.

As a related technique, a structure has been proposed, which enables an optical element material on a lower die to return to the center due to gravity even if the optical element material is displaced from the center of a forming surface, and which prevents the optical element material from being subjected to forming in a state of being displaced from the center of the forming surface, by holding an upper die so that the upper die does not contact the optical element material before press forming (see, for example, Japanese Unexamined Patent Application, Publication No. 2007-091554). Further, a structure has been proposed, which prevents collection of air by releasing gas to a protruded groove provided on a forming surface even if air is trapped between an optical element material and the forming surface (see, for example, Japanese Unexamined Patent Application, Publication No. H08-337428).

### SUMMARY

A method of controlling an optical element manufacturing apparatus according to one aspect of the preset disclosure includes: heating a cavity that is formed of a pair of upper and lower dies and that is for forming of an optical element, to a first temperature where an optical element material softens and becomes formable by the pair of upper and lower dies; heating the cavity to a second temperature where the optical element material is deformed due to a weight of the optical element material in a state of not being in contact with the upper die, the second temperature being higher than the first temperature; and pressing the pair of upper and lower dies for transfer of forming surfaces of the pair of upper and lower dies onto the optical element material in the cavity, the forming surfaces being outside a range where a forming surface of a die has been transferred by the deformation due to the weight in the state where the optical element material is not in contact with the upper die at the second temperature.

The above and other features, advantages and technical and industrial significance of this invention will be better understood by reading the following detailed description of presently preferred embodiments of the disclosure, when considered in connection with the accompanying drawings.

### BRIEF DESCRIPTION OF THE DRAWINGS

FIG. 1 is a schematic diagram illustrating an example of a configuration of an optical element manufacturing apparatus according to a first embodiment;

FIG. 2 is a flow chart illustrating a procedure of control by a control unit in the optical element manufacturing apparatus illustrated in FIG. 1;

FIG. 3 is a diagram illustrating time dependence of temperature detected by temperature sensors provided in an upper die and a lower die illustrated in FIG. 1 and time dependence of pressure that press mechanisms apply to the upper die and lower die;

FIG. 4 is a sectional view of the upper die, the lower die, and an optical element material, at a second heating step illustrated in FIG. 2;

FIG. 5 is a sectional view of the upper die, the lower die, and the optical element material, at a pressing step illustrated in FIG. 2;

FIG. 6 is a diagram illustrating a procedure of control in an optical element manufacturing apparatus according to a related technique;

FIG. 7 is a sectional view of an optical element material and a lower die accommodated in a cavity of the optical element manufacturing apparatus according to the related technique;

FIG. 8 is a flow chart illustrating a procedure of control by an optical element manufacturing apparatus according to a second embodiment;

FIG. 9 is a diagram illustrating time dependence of temperature detected by temperature sensors provided in an upper die and a lower die, and time dependence of pressure that press mechanisms apply to the upper die and lower die, according to the second embodiment;

FIG. 10 is a diagram illustrating time dependence of temperature detected by temperature sensors provided in an upper die and a lower die, and time dependence of pressure that press mechanisms apply to the upper die and lower die, according to a third embodiment;

FIG. 11 is a flow chart illustrating a procedure of control by an optical element manufacturing apparatus according to a fourth embodiment;

FIG. 12 is a diagram illustrating time dependence of temperature detected by temperature sensors provided in an upper die and a lower die, and time dependence of pressure that press mechanisms apply to the upper die and lower die, according to the fourth embodiment; and

FIG. 13 is a diagram illustrating time dependence of temperature detected by temperature sensors provided in an upper die and a lower die, and time dependence of pressure that press mechanisms apply to the upper die and lower die, in a case where the second embodiment is combined with the fourth embodiment.

### DETAILED DESCRIPTION

Hereinafter, embodiments of the present disclosure will be described while reference is made to the drawings. The present disclosure is not limited by these embodiments. Further, the same reference signs are used to refer to the same portions throughout the drawings.

### First Embodiment

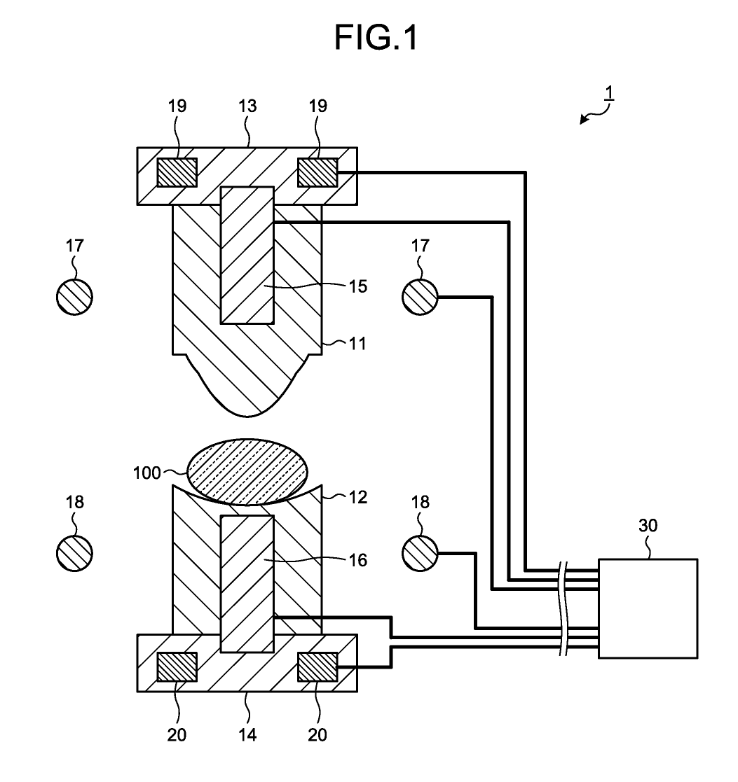

FIG. 1 is a schematic diagram illustrating an example of a configuration of an optical element manufacturing apparatus according to a first embodiment. An optical element manufacturing apparatus 1 illustrated in FIG. 1 is an apparatus for manufacture of an optical element by so-called press forming, in which a thermoplastic optical element material, such as glass, is pressed while being heated by use of a forming die.

The optical element manufacturing apparatus 1 includes: an upper die 11 and a lower die 12 (a pair of upper and lower dies) that press an optical element material 100, and form a pair; press mechanisms 13 and 14 (a pressing unit) that apply press load to the upper die 11 and lower die 12, and press the upper die 11 and lower die 12; heaters 15 and 16 (a heating unit) that respectively heat the upper die 11 and lower die 12 independently; heaters 17 and 18 (a heating unit) that are respectively provided around the upper die 11 and lower die 12; cooling units 19 and 20 that are respectively provided in the upper die 11 and lower die 12; and a control unit 30 that controls processing operation of the press mechanisms 13 and 14, the heaters 15 to 18, and the cooling units 19 and 20. Each of the upper die 11 and lower die 12 has a temperature sensor (not illustrated in the drawings), such as a thermocouple, provided therein.

As the optical element material 100, a glass material for press forming is used, the glass material having both of its end faces polished beforehand. The optical element material 100 for forming of an optical element is accommodated in a cavity formed of the upper die 11 and the lower die 12. By transferring shapes of transfer surfaces of the upper die 11 and lower die 12 onto both surfaces of the optical element material 100, the optical element manufacturing apparatus 1 manufactures an optical element having optical functional surfaces formed thereon, the optical functional surfaces demonstrating lens functions. An optical functional surface is a range of an optical element, such as a lens, the range being where light is actually passed when the optical element is used in an optical system.

The upper die 11 and lower die 12 are formed of ultra hard metal alloy, such as tungsten carbide (WC), or highly hard ceramic, such as silicon carbide (SiC), and each have a transfer surface that has been finished by grinding and polishing. Methods of finishing the transfer surfaces include, for example, the following methods, and are desirably selected according to surface roughness and shape accuracy of the dies demanded, but are not particularly limited.

Grinding finishing may be executed in a grinding step according to: a process, which is described in Japanese Unexamined Patent Application, Publication No. 2002-131510, and in which grinding is carried out with one point in a grindstone being controlled in a normal direction of a die; or a process, which is described in Japanese Unexamined Patent Application, Publication No. 2002-254280, and in which grinding is carried out while a contact point between a grindstone and a die is moved.

Next, in a polishing step: a method, in which a smoothing step is carried out, the smoothing step enabling only protruded portions to be selectively removed from waviness, cracks, and the like that are present on a surface of a die, as described in Japanese Unexamined Patent Application, Publication No. 2006-055964; a method, in which polishing for correction of a shape of a surface is carried out by use of a hard spherical tool, and final polishing into a desired shape is carried out, as described in Japanese Unexamined Patent Application, Publication No. 2011-036973; or a combination of these methods, may be implemented. However, the polishing by use of the hard spherical tool tends to cause increase in surface roughness of the die and shape waviness of a minute width. If these are desired to be prevented, a method, in which polishing is carried out via an elastic body by use of a polishing tool, as described in Japanese Patent No. 5399167 is effective. In this Japanese Patent No. 5399167, a method, in which the entire surface is polished while the polishing tool via the elastic body is kept at a specific angle, is described, but with this method, shape accuracy of the central portion may be degraded, or shape accuracy of the outermost periphery of the die may be degraded. Thus, polishing may be carried out by use of a method, in which the slant direction is changed between the outermost periphery and the central portion, instead of by the polishing tool via the elastic body being kept at the specific angle; and the rotation directions of the polishing tool and the die in that polishing are preferably set to directions in which their relative velocity at the contact position increases.

The optical element manufacturing apparatus 1 is an example of a fixed die type forming machine, in which the press mechanism 13 is always in contact with the upper die 11 and the press mechanism 14 is always in contact with the lower die 12.

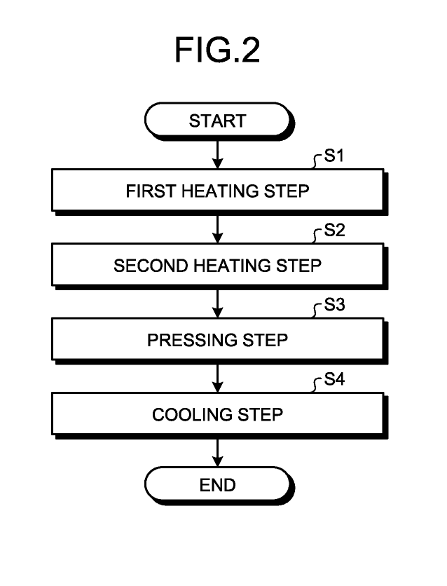

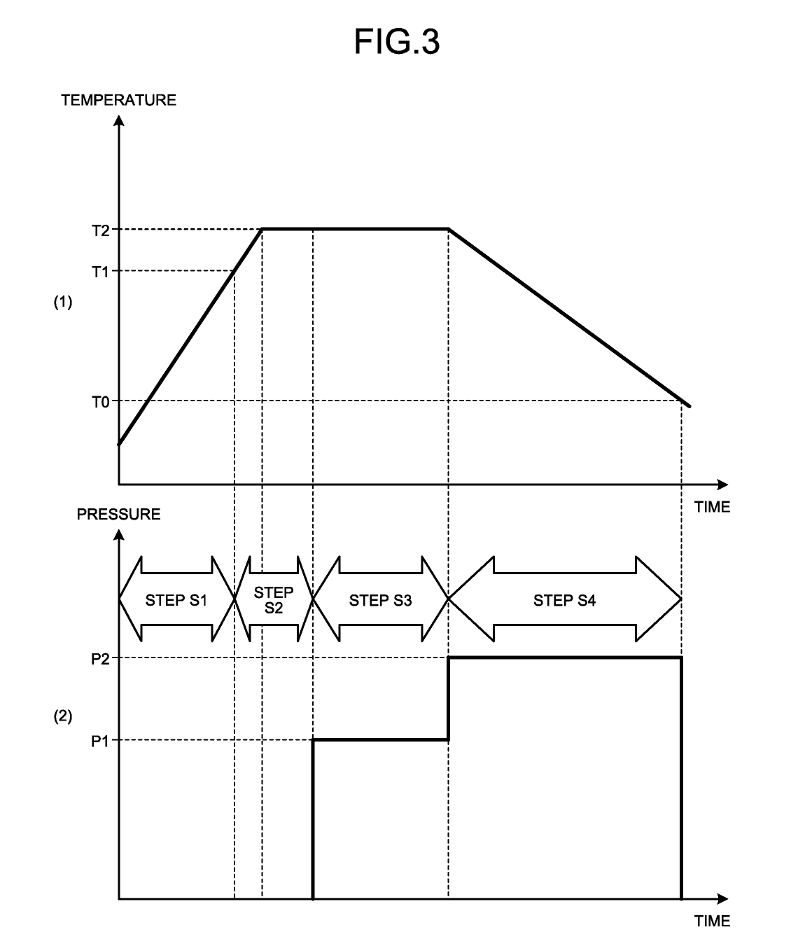

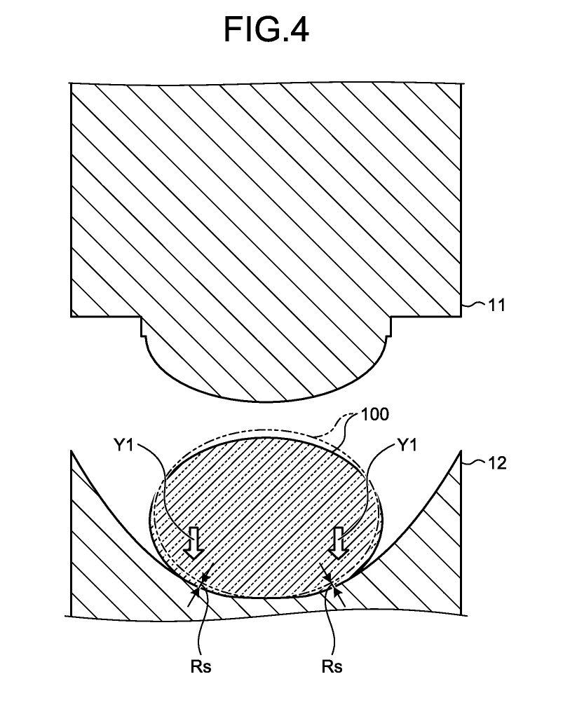

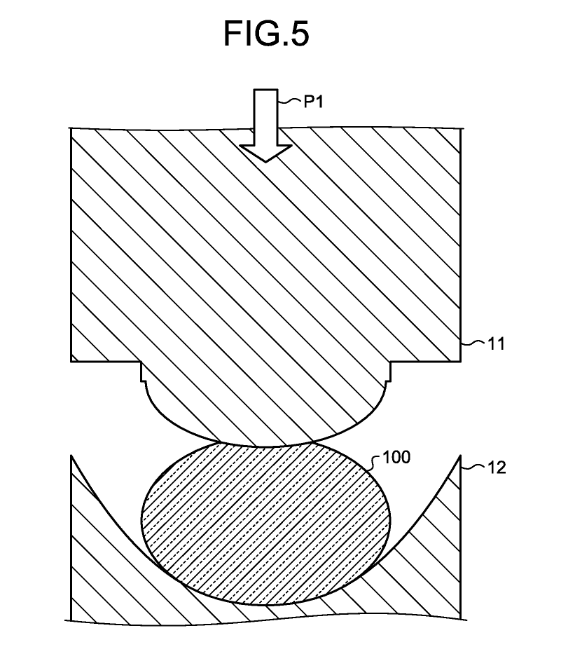

Next, a control method by the control unit 30 in the optical element manufacturing apparatus 1 illustrated in FIG. 1, and a method of manufacturing an optical element, will be described. FIG. 2 is a flow chart illustrating a procedure of control by the control unit 30 in the optical element manufacturing apparatus 1 illustrated in FIG. 1. FIG. 3 is a diagram illustrating time dependence ((1) in FIG. 3) of temperature detected by the temperature sensors provided in the upper die 11 and lower die 12, and time dependence ((2) in FIG. 3) of pressure that the press mechanisms 13 and 14 apply to the upper die 11 and lower die 12. FIG. 4 is a sectional view of the upper die 11, the lower die 12, and the optical element material 100, at a second heating step described later. FIG. 5 is a sectional view of the upper die 11, the lower die 12, and the optical element material 100, at a pressing step described later.

After the optical element material 100 is accommodated in the cavity, at a first heating step S1 illustrated in FIG. 2, the control unit 30 heats the cavity to a first temperature T1 (see (1) in FIG. 3), at which the optical element material 100 softens and becomes formable with the upper die 11 and lower die 12, by electrifying the heaters 15 to 18 while holding the upper die 11 in a state of not being in contact with the optical element material 100. As a result, a softening step, in which the optical element material 100 arranged in the cavity is heated to the first temperature T1 and the optical element material 100 is softened, is executed. The first temperature T1 is a temperature higher than a glass transition point T0 of the optical element material 100.

At a subsequent second heating step S2, by electrifying the heaters 15 to 18 while still holding the upper die 11 in the state of not being in contact with the optical element material 100, the control unit 30 heats the cavity to a second temperature T2 (>T1) (see FIG. 3), at which the optical element material 100 is deformed due to its own weight. By the cavity being heated to the second temperature T2, the optical element material 100 reaches a softness, at which the optical element material 100 is able to be deformed due to its own weight, and by the optical element material 100 being deformed such that the optical element material 100 comes into contact with at least a part of a forming surface of the lower die 12, the part including a top portion of the forming surface (see arrows Y1 in FIG. 4), a gap Rs that has been generated in the first heating step S1 between the optical element material 100 and the forming surface of the lower die 12 is eliminated. As a result of the execution of the second heating step S2 by the control unit 30, a primary deformation step is executed, at which the optical element material 100 is heated to the second temperature T2 and at least the part of the forming surface of the lower die 12 is transferred onto the optical element material 100, the part including the top portion of the forming surface.

At a subsequent pressing step S3, the control unit 30 applies a press load P1 (see (2) in FIG. 3 and FIG. 5) to the press mechanisms 13 and 14, and presses the upper die 11 and the lower die 12, in order to transfer a forming surface of the upper die 11 and the forming surface of the lower die 12 onto the optical element material 100 in the cavity. As a result, a secondary deformation step is executed, in which the optical element material 100 is pressed by the upper die 11 and lower die 12 and the forming surfaces are transferred onto the optical element material 100. The press load P1 is settable, as appropriate.

At a subsequent cooling step S4, while applying a press load P2 (>P1) (see (2) in FIG. 3) for the upper die 11 and lower die 12 to the press mechanisms 13 and 14, the control unit 30 electrifies the cooling units 19 and 20 and cools the cavity (see (1) in FIG. 3). As a result, temperatures of the optical element material 100 and the dies 11 and 12 are gradually decreased toward room temperature, and viscosity of the optical element material 100 is increased. The cooling step S4 is started, when pressing has advanced to a predetermined thickness thicker than the final central thickness in the pressing step S3. For obtainment of satisfactory optical surfaces, the press load needs to continue being applied during cooling of the dies also, and in anticipation of a thickness corresponding to deformation during the cooling, the cooling step S4 is started from a thickness thicker than the final thickness.

When a temperature, at which the optical element material 100 is not deformed, that is, when a temperature less than the glass transition point T0 is reached (see (1) in FIG. 3), the control unit 30 ends the cooling step S4, operates the press mechanism 13 to raise the upper die 11, and releases and takes out an optical element, which has been press-formed, from the upper die 11 and lower die 12. As a result, an optical element having optical functional surfaces formed on both surfaces thereof is able to be obtained. Subsequently, this optical element is subjected to heat treatment in a heat treatment furnace and its refractive index is adjusted. In this heat treatment, a surface, on which the optical element is placed, is preferably uniform. For example, the optical element may be placed on a member formed of alumina fiber or the like and having flexibility, or the optical element be placed on granular members, such as alumina balls, laid over a depth, by which sufficient flexibility of the placement surface is obtained, for example, grains of 02 mm laid over a depth of 5 mm or more.

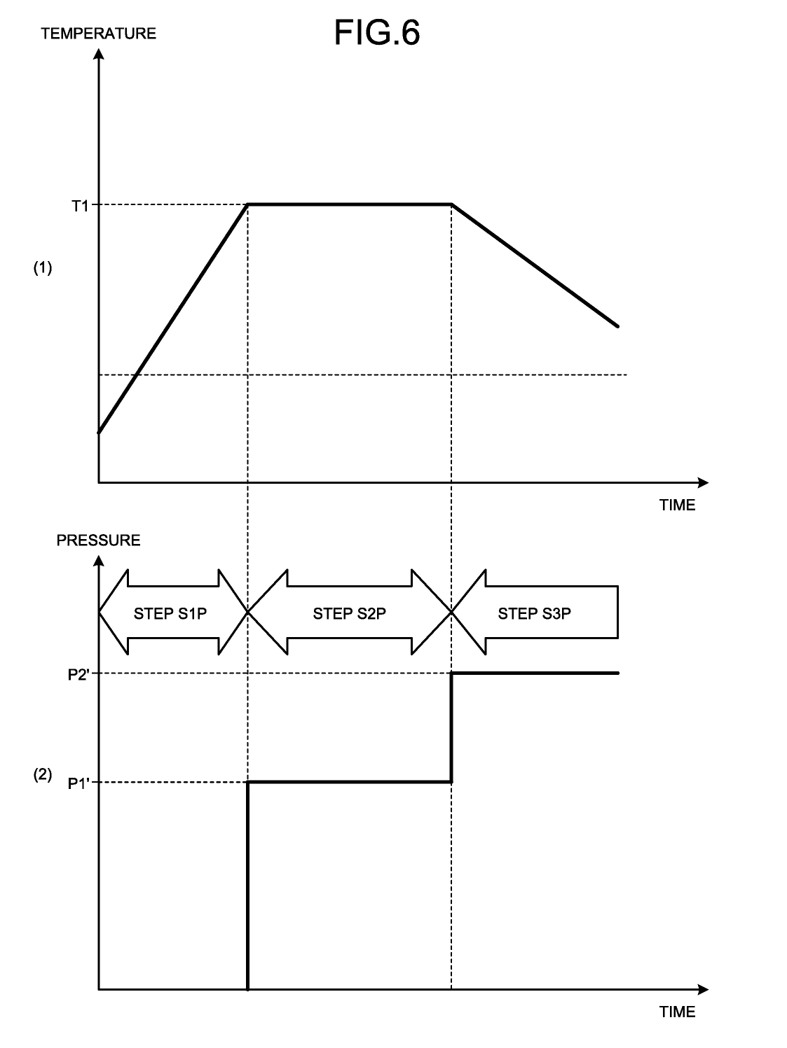

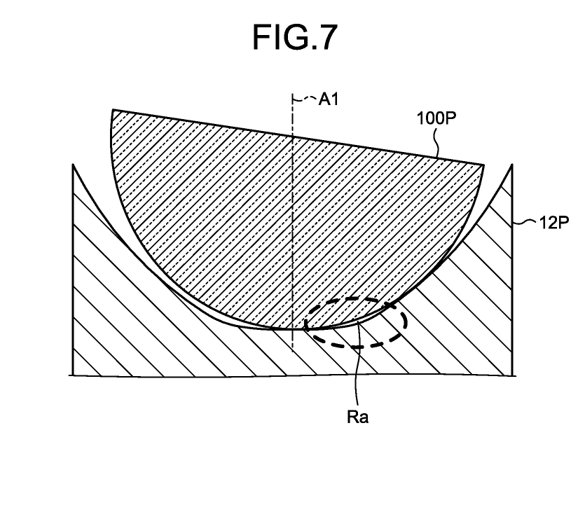

An optical element manufacturing apparatus according to a related technique will now be described. FIG. 6 is a diagram illustrating a procedure of control in the optical element manufacturing apparatus according to the related technique. FIG. 7 is a sectional view of an optical element material and a lower die accommodated in a cavity of the optical element manufacturing apparatus according to the related technique. In the optical element manufacturing apparatus according to the related technique, a control unit: at a heating step S1P, heats the cavity to a first temperature T1 (see (1) in FIG. 6); at a subsequent pressing step S2P, applies a press load P1′ to a press mechanism while maintaining the first temperature T1 and presses the pair of upper and lower dies; and thereafter executes a cooling step S3P of cooling the cavity while pressing the pair of upper and lower dies with a press load P2′. In the related technique, by positional displacement or slanting of an optical element material 100P (see FIG. 7) being caused when the pressing step S2P is started, and transfer being started from a position displaced from the central axis A1 of a forming surface of the lower die 12P; the transfer may not progress symmetrically about the central axis. When the pressing step S2P is executed in that state, a portion where gas Ra is trapped is generated between the optical element material 100P and the forming surface of the lower die 12P, in the periphery of a top portion of the forming surface, and collection of air is caused on the surface of the optical element.

In contrast, according to the first embodiment, as described above, by the execution of the second heating step S2 after the first heating step S1, the subsequent pressing step S3 is executed in the state where: the optical element material 100 has been caused to come into contact with at least the part of the forming surface of the lower die 12 by the self weight deformation, the part including the top portion of the forming surface; and the gap Rs has been eliminated: and thus even if the upper die 11 comes into contact with the optical element material 100, positional displacement or slanting of the optical element material 100 is not caused and collection of air is not caused, either.

From the above, according to this first embodiment, by the execution of the second heating step S2 of heating the cavity to the second temperature T2, at which the optical element material 100 is deformed due to its own weight, between the first heating step S1 and the pressing step S3, an effect that transfer symmetrical about the center of the forming surfaces of the dies is able to be realized in forming of the optical element is achieved.

The second temperature T2 may be set according to the glass type and the shape of the material, as long as the optical element material 100 is able to be deformed due to its own weight. Further, in the second heating step S2, for obtainment of self weight deformation, by isothermal holding at the second temperature T2 for a predetermined time period, self weight deformation is able to be obtained without excessive increase in the temperature of the dies, and durability of the dies is able to be increased. Of course, at the second heating step S2, after the heating to the second temperature T2, the temperature of the cavity may be gradually decreased.

Further, as the second temperature T2, a temperature, at which self weight deformation starts, may be found beforehand, according to the type, weight, and the like, of the optical element material 100. Or, at the time of manufacture of an optical element, start of self weight deformation of the optical element material 100 may be detected by visual observation or the like in a state where the heating has still been continued after the first heating step S1, and the temperature, at which the start of self weight deformation of the optical element material 100 is detected, may be set as the second temperature T2. Further, FIG. 3 illustrates an example, in which the heating speed in the first heating step S1 and the heating speed in the second heating step S2 are the same, but of course, the heating speeds may be different between the first heating step S1 and the second heating step S2.

### Second Embodiment

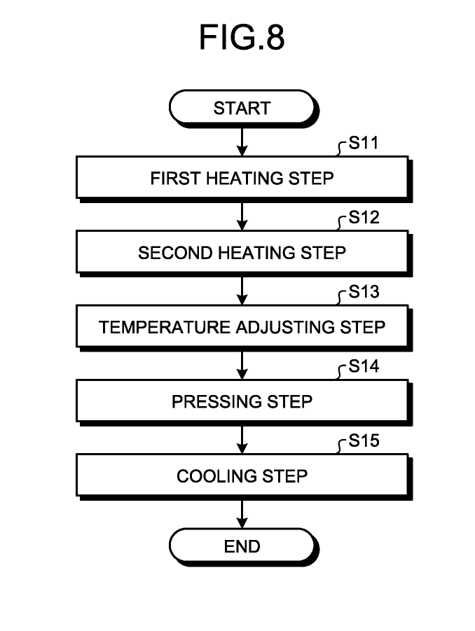

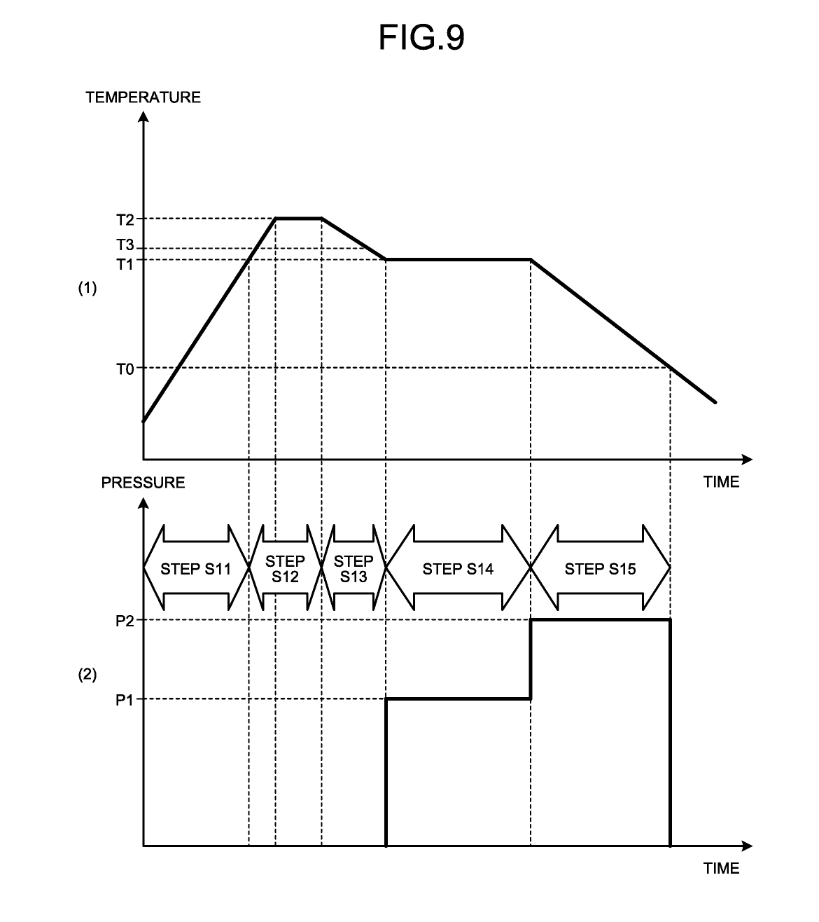

Next, a second embodiment will be described. A configuration of an optical element manufacturing apparatus according to the second embodiment is the same as that of the optical element manufacturing apparatus 1. FIG. 8 is a flow chart illustrating a procedure of control by the optical element manufacturing apparatus according to the second embodiment. FIG. 9 is a diagram illustrating time dependence ((1) in FIG. 9) of temperature detected by the temperature sensors provided in the upper die 11 and lower die 12, and time dependence (2) in FIG. 9) of pressure that the press mechanisms 13 and 14 apply to the upper die 11 and lower die 12, according to the second embodiment.

A first heating step S11, a second heating step S12, a pressing step S14, and a cooling step S15, which are illustrated in FIG. 8 and FIG. 9 are the first heating step S1, the second heating step S2, the pressing step S3, and the cooling step S4, which are illustrated in FIG. 2. According to the second embodiment, after the second heating step S12 and before the pressing step S14, a temperature adjusting step S13 of adjusting the cavity to a third temperature T3 (see (1) in FIG. 9), at which the optical element material 100 softens and is formable with the upper die 11 and lower die 12 but is not deformed due to its own weight, is executed, the third temperature T3 being between the first temperature T1 and the second temperature T2. Thereby, after the primary deformation step and before the secondary deformation step, a first viscosity adjusting step of increasing the viscosity of the optical element material 100 is executed.

In this second embodiment, by the execution of the temperature adjusting step S13, when the upper die 11 comes into contact with the optical element material 100 and pressing is carried out, the optical element material 100 has become harder as compared to the case of the first embodiment, and thus, even if a high load continues to be applied after start of cooling, room for deformation is able to be made small, and without control of the deformation after the start of cooling, the final thickness of the optical element is able to be stabilized easily.

### Third Embodiment

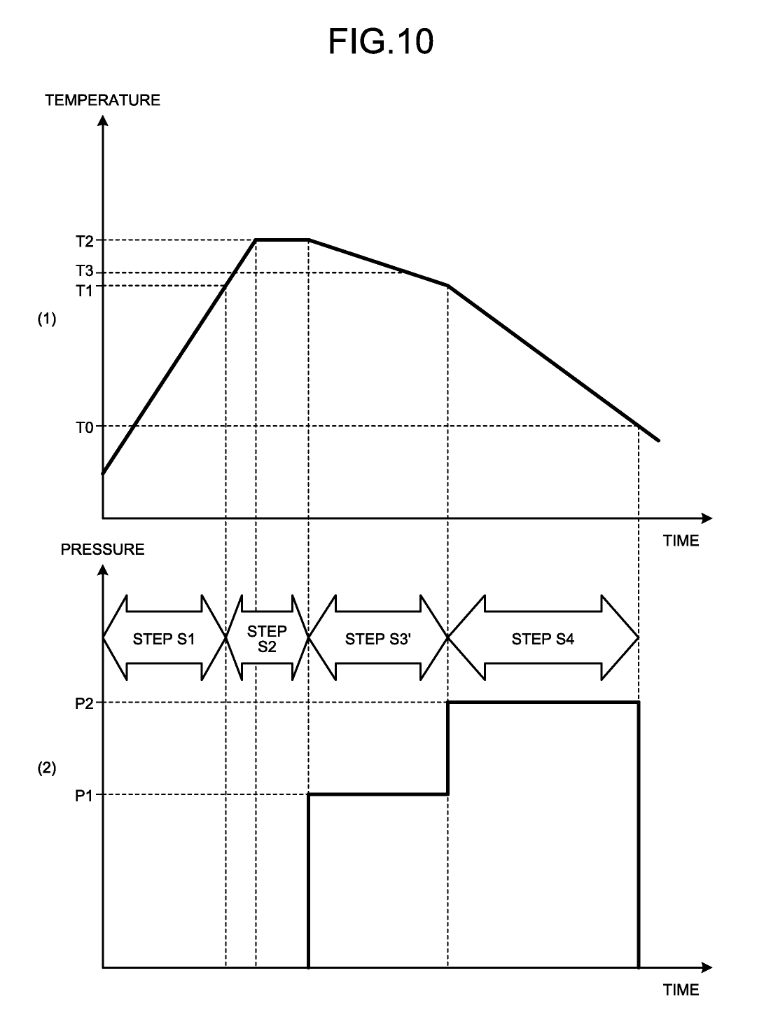

Next, a third embodiment will be described. A configuration of an optical element manufacturing apparatus according to the third embodiment is the same as that of the optical element manufacturing apparatus 1. FIG. 10 is a diagram illustrating time dependence ((1) in FIG. 10) of temperature detected by the temperature sensors provided in the upper die 11 and lower die 12, and time dependence ((2) in FIG. 10) of pressure that the press mechanisms 13 and 14 apply to the upper die 11 and lower die 12, according to the third embodiment.

A viscosity adjusting step is preferably after the second heating step S2 and before the start of the cooling step S4, like a viscosity adjusting step S3′ illustrated in FIG. 10, and may be executed by the temperature of the cavity being decreased after the upper die 11 comes into contact with the optical element material 100 after pressing by the press mechanisms 13 and 14 is started. Thereby, the time period required for adjustment of the viscosity of the optical element material 100 is able to be decreased. Further, thereby, the amount of pressing in the state where the optical element material 100 is hard and the deformation speed is slow is able to be decreased, and productivity is able to be increased by decrease in the time period required for manufacture of optical elements.

### Fourth Embodiment

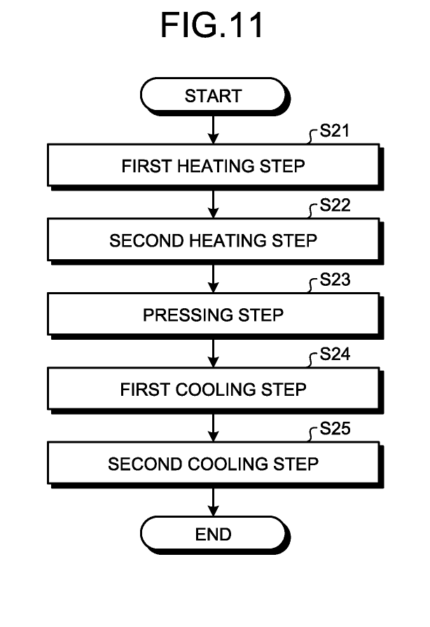

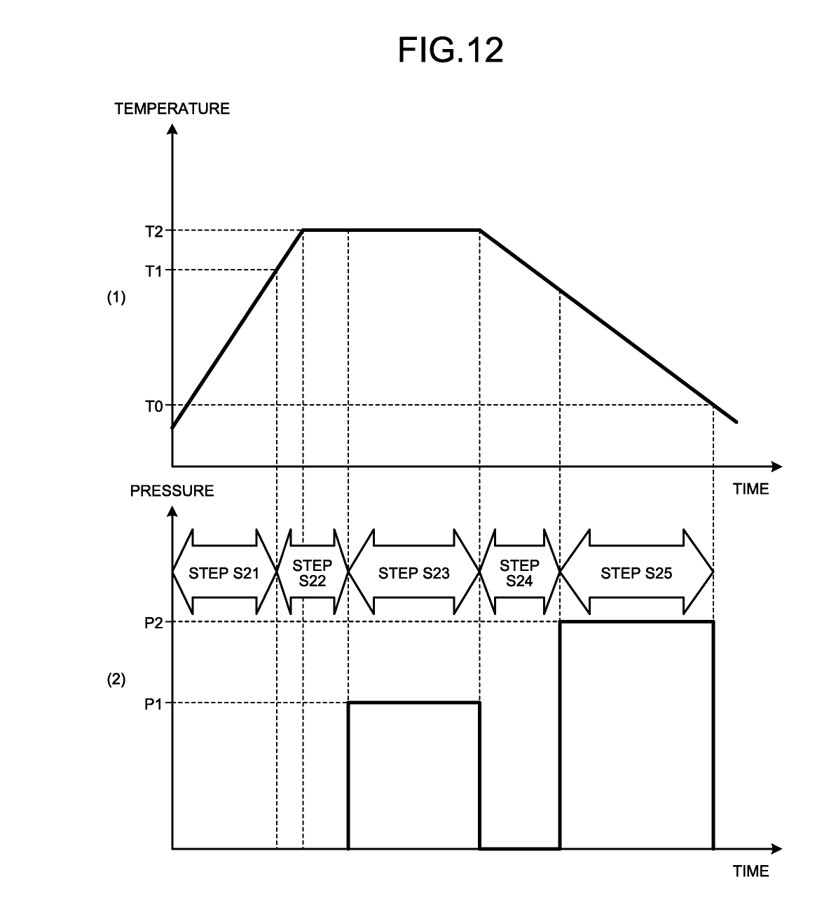

Next, a fourth embodiment will be described. A configuration of an optical element manufacturing apparatus according to the fourth embodiment is the same as that of the optical element manufacturing apparatus 1. FIG. 11 is a flow chart illustrating a procedure of control by the optical element manufacturing apparatus according to the fourth embodiment. FIG. 12 is a diagram illustrating time dependence ((1) in FIG. 12) of temperature detected by the temperature sensors provided in the upper die 11 and lower die 12, and time dependence ((2) in FIG. 12) of pressure that the press mechanisms 13 and 14 apply to the upper die 11 and lower die 12, according to the fourth embodiment.

A first heating step S21, a second heating step S22, and a pressing step S23, which are illustrated in FIG. 11 and FIG. 12 are the first heating step S1, the second heating step S2, and the pressing step S3, which are illustrated in FIG. 2. In this fourth embodiment, after the pressing step S23, a first cooling step S24 of cooling the cavity while decreasing the press load on the upper die 11 and lower die 12 to a press load lower than the press load P1 applied in the pressing step S23 is executed. For example, in the first cooling step S24, the press load is eliminated. As a result, after the secondary deformation step, a second viscosity adjusting step of decreasing the press load on the upper die 11 and lower die 12 to a press load lower than the press load applied in the secondary deformation step while increasing the viscosity of the optical element material 100 is executed.

At a subsequent second cooling step S25, the optical element manufacturing apparatus applies the press load P2 higher than the press load at the first cooling step S24 to the upper die 11 and lower die 12, and cools the cavity. As a result, after the second viscosity adjusting step, a third viscosity adjusting step of increasing the press load on the upper die 11 and lower die 12 to a press load higher than the press load in the first viscosity adjusting step while further increasing the viscosity of the optical element material 100 is executed.

Like in this fourth embodiment, after the pressing step S23, the first cooling step S24, in which, by the press load being decreased simultaneously with the start of cooling of the cavity and the viscosity of the optical element material 100 being increased, deformation of the optical element material 100 is reduced, and the second cooling step S25, in which the press load P2 is applied again after the temperature of the cavity is decreased and the viscosity of the optical element material 100 is increased in a range where a satisfactory optical surface is obtained, may be executed. Thereby, room for deformation after the start of cooling of the cavity is able to be made even smaller, and the final thickness is able to be stabilized easily without control of the deformation after the start of cooling.

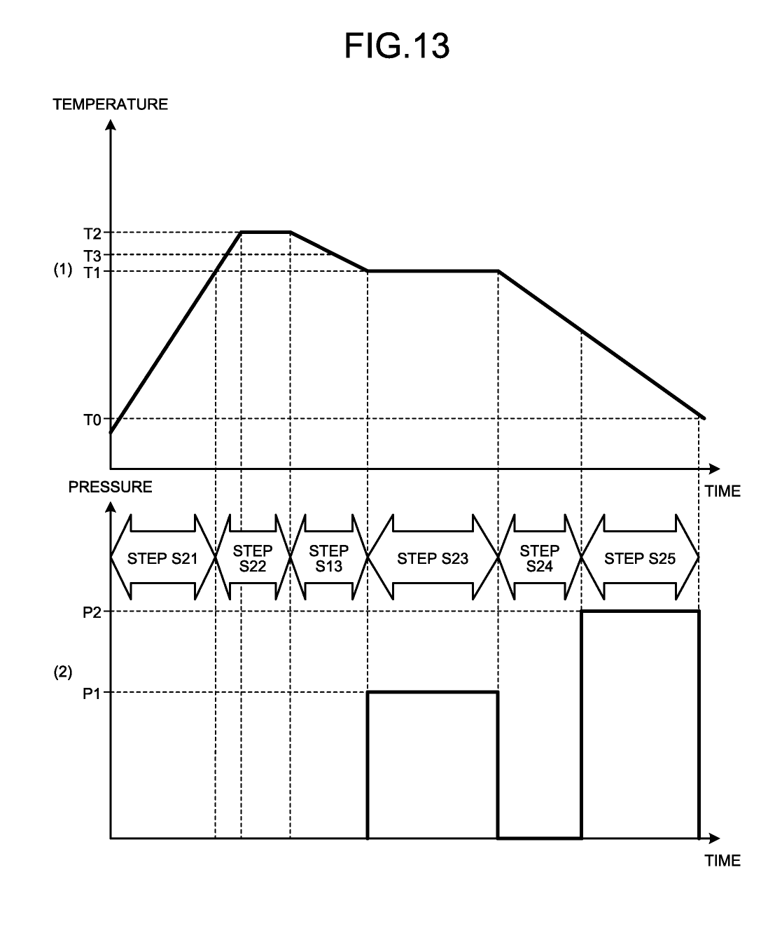

Any of the first to fourth embodiments may be combined with one another. FIG. 13 is a diagram illustrating time dependence ((1) in FIG. 13) of temperature detected by the temperature sensors provided in the upper die 11 and lower die 12, and time dependence ((2) in FIG. 13) of pressure that the press mechanisms 13 and 14 apply to the upper die 11 and lower die 12, in a case where the second embodiment is combined with the fourth embodiment. As illustrated in FIG. 13, further stabilization of the final thickness of the optical element may be undertaken, by adjustment of the viscosity of the optical element material 100 before the pressing step S23, and reduction of room for deformation in the pressing step S23, through execution of the temperature adjusting step S13 according to the second embodiment between the second heating step S22 and the pressing step S23 according to the fourth embodiment.

In each of the above described first to fourth embodiments, a so-called uniaxial type optical element manufacturing apparatus, which sequentially executes a heating step, a pressing step, and a cooling step, on a single stage, has been described as an example. However, a modified example of the above described first to fourth embodiments may be applied to a so-called cyclic type optical element manufacturing apparatus, which sequentially conveys a forming die having an optical element material set therein, to plural stages, and executes a heating step, a pressing step, and a cooling step, respectively on the stages at the conveyance destinations (for example, see Japanese Unexamined Patent Application, Publication No. 2005-126325).

In any of the first to fourth embodiments, a deformation promoting member that applies static load to the optical element material 100 and promotes the self weight deformation may be provided separately from the upper die 11. For example, a ring shaped member is placed in an outer peripheral portion of the optical element material 100. Further, in an example applied to a cyclic type optical element manufacturing apparatus, a member, by which additional load is applied to the upper die, is provided.

In the first to fourth embodiments, forming of aspherically shaped concave meniscus optical elements has been described as an example, but that is just an example, and the embodiments are not limited to this example. For example, the first to fourth embodiments are applicable to forming of optical elements including: a biconcave-shaped optical element; a biconvex-shaped optical element; and an optical element including a Fresnel surface or an inflection point.

The present disclosure described above is not limited to the first to fourth embodiments, and may be variously modified according to specifications and the like; and for example, formation may be made by exclusion of some components from all of the components described with respect to any of the first to fourth embodiments. From the above description, it is evident that within the scope of the present disclosure, various other embodiments are possible.

Additional advantages and modifications will readily occur to those skilled in the art. Therefore, the disclosure in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method of controlling an optical element manufacturing apparatus, comprising:
heating a cavity that is formed of a pair of upper and lower dies and that is for forming of an optical element, to a first temperature where an optical element material softens and becomes formable by the pair of upper and lower dies;
heating the cavity to a second temperature where the optical element material is deformed due to a weight of the optical element material in a state of not being in contact with the upper die, the second temperature being higher than the first temperature; and
pressing the pair of upper and lower dies for transfer of forming surfaces of the pair of upper and lower dies onto the optical element material in the cavity, the forming surfaces being outside a range where a forming surface of a die has been transferred by the deformation due to the weight in the state where the optical element material is not in contact with the upper die at the second temperature.

2. The method of controlling an optical element manufacturing apparatus according to claim 1, wherein the cavity is adjusted to a third temperature where the optical element material softens and is formable by the pair of upper and lower dies but is not deformed due to the weight, after being heated to the second temperature and before the pressing, the third temperature being between the first temperature and the second temperature.

3. The method of controlling an optical element manufacturing apparatus according to claim 1, further comprising:
cooling the cavity, after the pressing, while load on the pair of upper and lower dies is decreased to a load lower than a load applied in the pressing; and
applying a load higher than the load in the cooling to the pair of upper and lower dies, and cooling the cavity.

4. A method of manufacturing an optical element, comprising:
heating an optical element material arranged in a cavity that is formed of a pair of upper and lower dies and that is for forming of the optical element, to a first temperature, and softening the optical element material;
heating the optical element material to a second temperature higher than the first temperature, and transferring at least a part of a forming surface of the lower die of the pair of upper and lower dies, the part including a top portion of the forming surface; and
pressing the optical element material with the pair of upper and lower dies and transferring a forming surface.

5. The method of manufacturing an optical element according to claim 4, wherein viscosity of the optical element material is increased, after at least the part of the forming surface of the lower die is transferred, the part including the top portion of the forming surface, and before the optical element material is pressed with the pair of upper and lower dies and the forming surface is transferred.

6. The method of manufacturing an optical element according to claim 5, wherein
after the optical element material is pressed with the pair of upper and lower dies and the forming surface is transferred, load on the pair of upper and lower dies is decreased to a load lower than a load applied when the optical element material was pressed with the pair of upper and lower dies and the forming surface was transferred, while the viscosity of the optical element material is increased, and
thereafter, while the viscosity of the optical element material is increased, the load on the pair of upper and lower dies is increased to a load that is higher than a load applied when the viscosity of the optical element material is increased after at least the part of the forming surface of the lower die is transferred, the part including the top portion of the forming surface, and before the optical element material is pressed with the pair of upper and lower dies and the forming surface is transferred.

7. An optical element manufacturing apparatus comprising:
a pair of upper and lower dies;
a heating unit configured to heat a cavity formed of the pair of upper and lower dies, the cavity being for forming of an optical element;
a pressing unit configured to press the pair of upper and lower dies;
a cooling unit configured to cool the cavity; and
a control unit configured to
cause the heating unit to heat the cavity where an optical element material has been accommodated, to a second temperature where the optical element material is deformed due to a weight of the optical element material, after heating the cavity to a first temperature where the optical element material softens and becomes formable by the pair of upper and lower dies, the second temperature being higher than the first temperature, and
thereafter cause the pressing unit to press the pair of upper and lower dies for transfer of forming surfaces of the pair of upper and lower dies onto the optical element material in the cavity.
